(19) United States
(12) Patent Application Publication
(10) Pub. No.: US 2010/0030830 A1
(43) Pub. Date: Feb. 4, 2010

(54) Method of predicting of signal processes via separation on band-limited and high-frequency components

(76) Inventor: Nikolai Dokuchaev, Peterborough (CA)

Correspondence Address: Nikolai Dokuchaev, Unit 206, 2650 Marsdale Dr., Peterborough, ON, K9L1Y1, CA

(21) Appl. No.: 12/497,868

(22) Filed: Jul. 6, 2009

Related U.S. Application Data
(60) Provisional application No. 61/084,658, filed on Jul. 30, 2008.

(51) Int. Cl. G06F 17/10; G06F 17/14; G06F 7/38

(52) U.S. Cl. 708/300; 708/403; 708/444

(57) ABSTRACT

A method of prediction is suggested for the characteristics of future values of processes that can be expressed as integrals over future times with different weight functions (kernels), or as anticausal convolution integrals. In particular, all band-limited processes processes are predictable in this sense, as well as high-frequency processes, with zero energy at low frequencies. In addition, process of mixed type can still be predicted using low-pass filter and high-pass filter for this process, to provide separation on low-band and high frequency processes. It is allowed that an outcome of low-pass filter be not a purely band-limited process, but have exponential decay of energy on high frequencies. The algorithm suggested consists of two blocks: separation of a process on band-limited and high-frequency components, and approximation of the transfer function of the anticausal integral that has to be predicted by transfer functions for causal convolution integrals. This approximation has to be done separately for high frequency domain and low band domain.

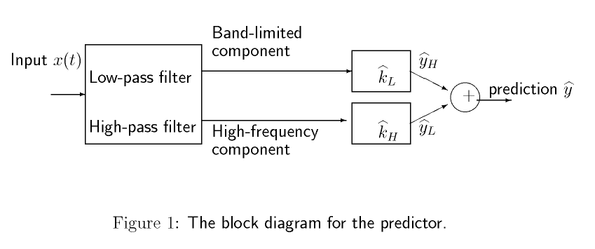

This application claims priority to provisional patent application No. 61/084,658 filed on Jul. 30, 2008 by Nikolai Dokuchaev

### CROSS-REFERENCES TO RELATED APPLICATIONS

non applicable

### STATEMENT OF FEDERALLY SPONSORED RETURNS

non-applicable

### REFERENCE TO A SEQUENCE LISTING

non applicable

### BACKGROUND OF THE INVENTION

1.1. Field of the Invention

This invention relates to the problem of prediction of certain characteristics of signal processes.

1.2 Description of Related Art

It is well known that band-limited processes are predictable. The formulas for linear predictors in the form of transfer functions as well as in the form of integral operators can be found in the following publications:
Wainstein L. A. and Zubakov V. D. (1962),Extraction of Signals from Noise. Englewood Cliffs, N.J.: Prentice-Hall.
Beutler F. G. (1966), Error-free recovery of signals from irregularly spaced samples. SIAM Review, 8(3), 328-335.
Brown J. R., Jr. (1969), Bounds for truncation error in sampling expansion of band-limited signals. IEEE Transactions Inform. Theory 15, no. 4, 440-444.
Slepian D. (1978), Prolate spheroidal wave functions, Fourier analysis, and uncertainty V: The discrete case. Bell System Technical Journal, 57(5), 1371-1430.
Knab J. J. (1981), Interpolation of band-limited functions using the approximate prolate series. IEEE Transactions on Information Theory 25(6), 717-720.
Papoulis A. (1985), A note on the predictability of band-limited processes. Proceedings of the IEEE, 73(8), 1332-1333.
Marvasti F. (1986), Comments on “A note on the predictability of band-limited processes.” Proceedings of the IEEE, 74(11), 1596.
Vaidyanathan P. P. c (1987), On predicting a band-limited signal based on past sample values. Proceedings of the IEEE, 75(8), 1125-1127.
Lyman R. J, Edmonson W. W., McCullough S., and Rao M. (2000). The predictability of continuous-time, bandlimited processes. IEEE Transactions on Signal Processing 48, Iss. 2, 311-316.

The crucial assumption was that the processes are band-limited; see, e.g., the discussion in Chapter 17 from Higgins, J. R. (1996). Sampling Theory in Fourier and Signal Analysis. Oxford University Press, New York.

There are many previously known transfer functions and formulas for low-pass and high-pass filters.

### 1.2.1 On the Related Provisional Patent Application

The invention was disclosed in provisional patent application Provisional USA patent “Method of predicting of processes based on separation on low-band and high-frequency component”, filed by Nikolai Dokuchaev in Aug. 1, 2008; application No. 61/084,658. T Before that, a part of this invention was disclosed in the working paper placed in web-archive of Los-Alamos National laboratory (http://lanl.arxiv.org/abs/0708.0347, posted on web on Aug. 2, 2007, and http://lanl.arxiv.org/abs/0811.2623 (posted on web on Nov. 17, 2008).

In addition, the following paper was published: Dokuchaev, N. G. (2008). The predictability of band-limited, high-frequency, and mixed processes in the presence of ideal low-pass filters. Journal of Physics A: Mathematical and Theoretical 41 No 38, 382002 (7 pp).

Note that the application for the provisional patent was submitted earlier than one year after the paper mentioned was placed on web.

1.3 Objectives of the Invention

The goal is to create predicting system blocks for signal processes processes that are not necessarily band-limited.

### BRIEF SUMMARY

### The Abstract of Disclosure

Our method suggests a way of prediction of the characteristics of future values of processes that can be expressed as integrals over future times with different weight functions (kernels), or as anticausal convolution integrals. In particular, all band-limited processes and high-frequency processes are predictable in this sense, as well as purely high-frequency processes, with zero energy at low frequencies. In addition, process of mixed type can still be predicted using low-pass filter and high-pass filter for this process, to provide separation on low-band and high frequency processes. It is allowed that an outcome of low-pass filter be not a purely band-limited process, but have some small enough energy on high frequencies.

The algorithm suggested consists of two blocks:

(1) Separation of a process on band-limited and high-frequency components using low pass filter and high pass filters;

(2) Approximation of the transfer function of the anticausal integral that has to be predicted by transfer functions for causal convolution integrals. This approximation has to be done separately for high frequency domain and low band domain.

Together, these two steps ensure prediction via approximation of convolution integrals over future time by integrals over past time.

The main technical achievement is construction of approximating transfer functions.

### BRIEF DESCRIPTION OF THE DRAWING

Given on the drawing, is the block diagram of the system consisting of a filter that separates a signal on band-limited and high-frequency parts, and a predictor that form output process ŷ(t).

### DETAILED DESCRIPTION OF THE INVENTION

### Characteristics that are Predicted

Let x(t) be a process of interests that is currently observable; t represents the time. For any time t, the values x(s) are available for all previous times s≦t.

The goal is to estimate values

$$y ( t ) = {\int }_{t}^{t + T} k ( t - s ) x ( s ) d s ,$$

where k is some given weight, T is the prediction horizon. Since this integral depends at time t on the future values of x(s), this estimation is in fact prediction of future of x(t).

We present linear predictors such that the values of

$$y ( t ) = {\int }_{t}^{t + T} k ( t - s ) x ( s ) d s$$

are estimated as

$$\hat{y} ( t ) = {\int }_{- ∞}^{t} \hat{k} ( t - s ) x ( s ) d s$$

for the processes y(t), where \hat{k} is some weight function that is given explicitly in the frequency domain, i.e., it is described via its Fourier transform. The corresponding transfer functions are claimed as a part of this invention.

### The Suggested Method

The suggested method of predicting of processes consists of two steps: first, separation of a process on band-limited and high-frequency components, and second, approximation of the transfer function of the anticausal integral to be predicted by a transfer function for causal convolution integrals.

We suggest below different types of the transfer functions for the predicting blocks that have to be used for the filtered processes, i.e., immediately after the application of filters. These three transfer functions are supposed to be used as the limits that can be approximated by linear circuits with rational fractions as transfer functions.

First, we suggest the transfer function for the predicting system block for band-limited processes; these processes can be obtained as the outcome of a low-pass filter applied to the original process.

Second, we suggest the transfer function for the predictor for high-frequency processes; these processes can be obtained as the outcome of a low-pass filter applied to the original process.

Third, we suggest the transfer function for the predictors that can be used for prediction on the finite horizon of some processes that are not necessary band-limited but such that the energy on the higher frequency with an exponential rate of decay. These processes can be obtained as the outcome of a low-pass filter applied to the original process, in the case when the filter is not perfect and there is some remaining energy on higher frequencies domains.

5.1 Transfer Function for Predictors for Band-Limited and High-Frequency Processes

Let R be the set of real numbers, C be the set of complex numbers. C⁺ [symbol] { [symbol] εC: Re [symbol] >0}, i=\sqrt{−1}.

For complex valued functions x, we denote by X= [symbol] x the function defined on iR as the Fourier transform of x.

For v(•)εL₂(R) such that v(t)=0 for t<0, we denote by [symbol] v the Laplace transform. Let Ω>0 be given.

Let [symbol] be the class of weight functions k:R→R such that k(t)=0 for t>0 and such that the Fourier transform is K= [symbol] k is

$$K ( iω ) = \frac{α ( iω )}{δ ( iω )} , \qquad ( 5.1 )$$

where α(•) and δ(•) are polynomials such that deg d<deg δ, and if δ(p)=0 for pεC then Re p>0, |Im p|<Ω.

Note that the class [symbol] is quite wide: it consists of linear combinations of functions q(t)e^{λt} [symbol] _{{t≦0}}, where λεC is such that Re λ>0, |Im λ|<Ω, and where q(t) is a polynomial, and where [symbol] is the indicator function. Let k(•) be the anticausal kernel and let K(iω) be its representation in frequency domain. Let K(p)=α(p)/δ(p) with a polynomial α(p) and with

$$δ ( p ) = {\prod }_{m = 1}^{n} {δ}_{m} ( p ) ,$$

where δₘ(p) [symbol] p−aₘ+bₘi, and where aₘ, bₘεR, pεC. By the assumptions on [symbol] , we have that aₘ>0 and |bₘ|<Ω.

### The Formula for the Transfer Function of the Predicting Kernel

The predicting kernel \hat{k}(•)=\hat{k}(•,γ) is given by its frequency representation \hat{K}(iω) (i.e., as the Fourier transform of \hat{k}). For a numerical parameter γεR, set

$${α}_{m} = \frac{{Ω}^{2} - {b}_{m}^{2}}{{a}_{m}} , {V}_{m} ( p ) {=}^{△} 1 - exp ( γ \frac{p - {a}_{m} + {b}_{m} i}{p + {α}_{m} - {b}_{m} i} ) , \\ V ( p ) {=}^{△} {\prod }_{m = 1}^{n} {V}_{m} ( p ) .$$

Then the transfer function is defined as

\hat{K}(iω) [symbol] V(iω)K(iω). (5.2)

These predictors have to be applied to the process being split on the band-limited part and high-frequency part, after application of low-pass filter.

For the case of the output of low-pass filter, this predictor has to be applied with the parameter γ>0.

For the case of the output of high-pass filter, this predictor has to be applied with the parameter γ<0.

5.2 Transfer Function for Predictors for Processes with Decreasing Energy on Higher Frequencies

We present now the modification of the transfer function for the case when the low pass filter is not ideal, and its output has some energy on higher frequencies. It is allowed that this energy be exponentially decreasing for large frequencies. The exact description of admissible signals is given below.

The predicting kernel \hat{k}(•)=\hat{k}(•,γ) is given by its frequency representation \hat{K}(iω) (i.e., as the Fourier transform of \hat{k}).

For a numerical parameter γ>0, set

$$g ( p ) {=}^{△} T \frac{γ - p}{γ + p} p , h ( p ) {=}^{△} g ( p ) - Tp , V ( p ) {=}^{△} {e}^{h ( p )} .$$

Then the transfer function is defined as

\hat{K}(iω) [symbol] V(iω)K(iω). (5.3)

5.3 Effectiveness of the Predictors

### 5.3.1 Effectiveness of the Predictor (5.2)

Predictor (5.2) allows us to estimate the values

$$y ( t ) = {\int }_{t}^{+ ∞} K ( t - s ) x ( s ) ,$$

by approximation of these values by

$$\hat{y} ( t ) = {\int }_{- ∞}^{t} \hat{k} ( t - s ) x ( s ) d s .$$

Property 5.1 Band-limited and high frequency processes are predictable in the following sense: processes

$$y ( t ) = {\int }_{t}^{+ ∞} k ( t - s ) x ( s ) d s$$

can be effectively approximated by processes

$$\hat{y} ( t ) {\int }_{- ∞}^{t} \hat{k} ( t - s ) x ( s ) d s$$

that use historical observations with kernel \hat{k} defined by (5.2), where γ>0 for band-limited processes, or γ<0 for high frequency processes respectively.
Property 5.2 Assume that a signal process x(•) is decomposed as x(t)=x_{L}(t)+x_{H}(t), where x_{L}(•) is a band-limited process and x_{H}(•) is a high frequency process. Then the observer can predict (approximately, in the sense of weak predictability) the values of

$$y ( t ) = {\int }_{t}^{+ ∞} k ( t - s ) x ( s ) d s for k ( \cdot ) ∈ K$$

by predicting the processes

$${y}_{L} ( t ) = {\int }_{t}^{+ ∞} k ( t - s ) {x}_{L} ( s ) d s and {y}_{H} ( t ) = {\int }_{t}^{+ ∞} k ( t - s ) {x}_{H} ( s ) d s$$

separately. More precisely, the process ŷ(t) [symbol] ŷ_{L}(t)+ŷ_{H}(t) is the prediction of y(t), where

$${y}_{L} ( t ) = {\int }_{- ∞}^{t} {\hat{k}}_{L} ( t - s ) {x}_{L} ( s ) d s and {y}_{H} ( t ) = {\int }_{- ∞}^{t} {\hat{k}}_{H} ( t - s ) {x}_{H} ( s ) d s ,$$

and where \hat{k}_{L}(•) and \hat{k}_{H}(•) are predicting kernels whose existence for the processes x_{L}(•) and x_{H}(•) is established above.

Let χ_{L}(ω) [symbol] _{{|ω|≦Ω}} and χ_{H}(Ω) [symbol] 1−χ_{L}(ω)= [symbol] _{{|ω|>Ω}}, where ωεR. It follows that the predictability in some sense is possible for any process x(•) that can be decomposed without error into a band limited process and a high-frequency process, i.e., when there is a low-pass filter. (Since x_{H}(t)=x(t)−x_{L}(t), existence of the law pass filter implies existence of the high pass filter). In reality, some error always exists for filters. If the error is large, then the prediction error can be large.

### 5.3.2 Effectiveness of Predictor (5.3)

Property 5.3 Consider a class of processes x(t) such that

∫_{R}e^{2|ω|T}|X(iω)|²dw<+∞, (5.4)

where X= [symbol] x is the Fourier transform of x. These processes are predictable, with the predicting kernel \hat{k} defined by (5.3), in the following sense: process

$$y ( t ) = {\int }_{t}^{t + T} k ( t - s ) x ( s ) d s$$

can be effectively approximated by processes

$$\hat{y} ( t ) = {\int }_{- ∞}^{t} \hat{k} ( t - s ) x ( s ) d s .$$

We assume that the admissible functions k(t) are continuous on the interval [−T, 0].
Remark 1 The predictors introduced above are stable, since the corresponding transfer functions do not have poles in the complex domain {z; Re z.}. In addition, these predictors are causal and robust with respect to the deviations of the process that are small with respect to the weighted norm defined by the estimate (5.4).
Remark 2 Formally, the predictor described above require the past values of x(s) for all sε(−∞,t], but it is not too restrictive, since

$${\int }_{- ∞}^{t} \hat{k} ( t - s ) x ( s ) d s$$

can be approximated by

$${\int }_{- M}^{t} \hat{k} ( t - s ) x ( s ) d s$$

for large enough M>0.

### 5.3.3 Supporting Calculations for Predictor (5.2)

In this section, we consider predictor (5.2).

Property 5.4 (i) the predictor are causal and physically realizable (more precisely, V(p)εH²∩H^{∞} and \hat{K}(p) [symbol] K(p)V(p)εH²∩H^{∞}, where H^{r} denote the set of transfer functions [symbol] holomorphic on C⁺ with finite norm ∥χ∥_{H}_{^{r}}=sup_{s>0}∥χ(s+iω)∥_{L}_{ᵣ}_{(R)}, rε[1, +∞].
(ii) If γ>0 and ωε[−Ω,Ω], then |V(iω)|≦1. If γ<0, and if ωεR, |ω|≧Ω, then |V(iω)|≦1.
(iii) If ωε(−Ω,Ω), then V(iω)→1 as γ→+∞. If ωεR and |ω|>Ω, then V(iω)→1 as γ→−∞.
(iv) For any ε>0, V(iω)→1 uniformly ωε[−Ω+ε,Ω−ε] as γ→+∞, and V(iω)→1 as γ→−∞ uniformly ωεR such that |ω|≧Ω+ε.

Let us explain why Property 5.4 holds. Clearly, Vₘ(p)εH^{∞}, and δₘ(p)⁻¹Vₘ (p)εH²∩H^{∞}, since the pole of δₘ(p)⁻¹ is being compensated by multiplying by Vₘ(p). It follows that K(p)V(p)εH²∩H^{∞}. Then statement (i) follows.

Further, for ωεR,

$$\begin{matrix}\frac{i ω - {a}_{m} + {b}_{m} i}{i ω + {α}_{m} - {b}_{m} i} = \frac{( - {a}_{m} + i ω + i {b}_{m} ) ( {α}_{m} - i ω + {b}_{m} i )}{{( ω - {b}_{m} )}^{2} + {a}_{m}^{2}} \\ = \frac{- {a}_{m} {α}_{m} + ( ω + {b}_{m} ) ( ω - {b}_{m} )}{{( ω - {b}_{m} )}^{2} + {α}_{m}^{2}} + \\ i \frac{- {a}_{m} ( ω + {b}_{m} ) + {α}_{m} ( ω + {b}_{m} )}{{( ω - {b}_{m} )}^{2} + {α}_{m}^{2}} .\end{matrix} \\ Then Re \frac{i ω - {a}_{m} + {b}_{m} i}{i ω + {α}_{m} - {b}_{m} i} = \frac{- {a}_{m} {α}_{m} + {ω}^{2} - {b}_{m}^{2}}{{( ω - {b}_{m} )}^{2} + {α}_{m}^{2}} = \frac{{ω}^{2} - {Ω}^{2}}{{( ω - {b}_{m} )}^{2} + {α}_{m}^{2}} .$$

Then statements (ii)-(iv) follow. This explains why Property 5.4 holds.

Let [symbol] ={x(•)} be a class of functions x: R→C. Let rε[1, +∞].
(i) Let [symbol] be the class of functions k. We say that a class of processes is Lᵣ-predictable in the weak sense if, for any k(•)ε [symbol] , there exists a sequence

$${\{ {\hat{k}}_{m} ( \cdot ) \}}_{m = 1}^{+ ∞} = {\{ {\hat{k}}_{m} ( \cdot , χ , k ) \}}_{m = 1}^{+ ∞} ⋐ \hat{K} such that$$

$${‖ y - {\hat{y}}_{m} ‖}_{{L}_{r} ( R )} \to 0 as m \to + ∞ ∀ x ∈ χ , \\ where$$

$$y ( t ) {=}^{△} {\int }_{t}^{+ ∞} k ( t - s ) x ( s ) d s , \\ {\hat{y}}_{m} ( t ) {=}^{△} {\int }_{- ∞}^{t} {\hat{k}}_{m} ( t - s ) x ( s ) d s .$$

(ii) Let the set [symbol] ( [symbol] ) [symbol] {X= [symbol] x, xε [symbol] } be provided with a norm ∥•∥. We say that the class [symbol] is Lᵣ-predictable in the weak sense uniformly with respect to the norm ∥•∥, if, for any k(•)ε [symbol] and ε>0 there exists \hat{k}(•)=\hat{k}(•, [symbol] k, ∥•∥) ε [symbol] such that

∥y−ŷ∥_{L}_{ᵣ}_{(R)}≦ε∥X∥∀xε [symbol] ,X= [symbol] x.

Here y(•) is the same as above,

$$\hat{y} ( t ) {=}^{△} {\int }_{- ∞}^{t} \hat{k} ( t - s ) x ( s ) d s .$$

Let Ω>0 be the same as in the definition of [symbol] , and let

[symbol]

_{L} [symbol] {x(•)εL₂(R):X(ω)=0 if |ω|>Ω, X= [symbol] x},

[symbol]

_{H} [symbol] {x(•)εL₂(R):X(Ω)=0 if |ω|<Ω, X= [symbol] x}.

In particular, [symbol] _{L} is a class of band-limited processes, and [symbol] _{H} is a class of high-frequency processes.
Property 5.5 (i) The classes [symbol] _{L} and [symbol] _{H} are L₂-predictable in the week sense.
(ii) The classes [symbol] _{L} and [symbol] _{H} are L_{∞}-predictable in the weak sense uniformly with respect to the norm ∥•∥_{L}_{₂}_{(R)}.
(iii) For any q>2, qε(2, +∞], the classes [symbol] _{L} and [symbol] _{H} are L₂-predictable in the weak sense uniformly with respect to the norm ∥•∥*_{L}_{_{q}}_{(R)}.
   Remark 3 Since the constant Ω the same for the classes K, [symbol] _{L}, [symbol] _{H}, the set of k(•)ε [symbol] such that the corresponding processes y(•) can be predicted is restricted for x(•)ε [symbol] _{H}. On the other hand, these restrictions are absent for band-limited processes x(•)ε [symbol] _{L}, since they are automatically included to all similar classes with larger Ω, i.e., the constant Ω in the definition of [symbol] _{L} can always be increased.

Let us show that Property 5.5 is satisfied.

For x(•)εL₂(R), let X [symbol] [symbol] x, Y [symbol] [symbol] y=K(iω)X(ω). Let V be as defined above. Set Ŷ(ω) [symbol] \hat{K}(iω)X(ω)=V(iω)Y(ω).

Let us consider the cases of [symbol] _{L} and [symbol] _{H} simultaneously. For the case of the class [symbol] _{L}, consider γ>0 and assume that γ>0 and γ→+∞. Set D [symbol] [−Ω,Ω] for this case. For the case of the class [symbol] _{H}, consider γ<0 and assume that γ<0 and γ→−∞. Set D [symbol] (−∞, −Ω]∪[Ω, +∞) for this case.

Let x(•)ε [symbol] _{L} or x(•)ε [symbol] _{H}. In both cases, Lemma 5.4 gives that |V(iω)|≦1 for all ωεD. If γ→+∞ or γ→−∞ respectively for [symbol] _{L} or [symbol] _{H} cases, then V(iω)→1 for a.e. ωεD, i.e., for a.e. ω such that X(ω)≠0.

Let us prove (i). Since K(iω)εL_{∞}(R) and XεL₂(R), we have that Y(ω)=K(iω)X(ω)εL₂(R) and YεL₂(R). By Property 5.4, it follows that

Ŷ(ω)→Y(ω) for a.e. ωεR, (5.5)

as γ→+∞ or γ→−∞ respectively for [symbol] _{L} or [symbol] _{H} cases. We have that Xε L₂(R), K(iω)εL₂(R)∪L_{∞}(R) and

|\hat{K}(iω)−K(iω)|≦|V(iω)−1∥K(iω)|≦2|K(iω)|,ωεD, (5.6)

|Ŷ(ω)−Y(ω)|≦2|Y(ω)|=2|K(iω)∥X(ω)|,ωεD. (5.7)

By (5.5),(5.7), and by Lebesgue Dominated Theorem, it follows that

∥Ŷ−Y∥_{L}_{₂}_{(R)}→0, i.e., ∥ŷ−y∥_{L}_{₂}_{(R)}→0 (5.8)

as γ→+∞ or γ→−∞ respectively for [symbol] _{L} or [symbol] _{H} cases, where ŷ= [symbol] ⁻¹Ŷ.

Let us prove (ii)-(iii). Take d=1 for (ii) and take d=2 for (iii). If XεL_{q}(R) for q>d, then Hölder inequality gives

∥Ŷ−Y∥_{L}_{_{d}}_{(R)}≦∥\hat{K}(iω)−K(iω)∥_{L}_{_{μ}}_{(D)}∥X∥_{L}_{_{q}}_{(D)}, (5.9)

where μ is such that 1/μ+1/q=1/d. By (5.6) and by Lebesgue Dominated Theorem again, it follows that

∥\hat{K}(iω)−K(iω)∥_{L}_{_{μ}}_{(D)}→0∀με[1,+∞) (5.10)

as γ→+∞ or γ→−∞ respectively for [symbol] _{L} or [symbol] _{H} cases. By (5.9)-(5.10), it follows that the predicting kernels \hat{k}(•)=\hat{k}(•,γ)= [symbol] ⁻¹\hat{K}(iω) are such as required in statements (ii)-(iii). This shows that Property 5.5 is satisfied.

### 5.3.4 Supporting Calculations for Predictor (5.3)

In this section, we consider predictor (5.3).

Let ψ(ε): (0, +∞)→R be any function such that, for zεC, if |z|≦ψ(ε) then |e^{z}−1|≦ε. It follows from the continuity of the function e^{z} that ψ(ε)>0 for any ε>0. For example, one can select ψ as the inverse function to the modulus of continuity at zero for the exponent function e^{z}.

Property 5.6 (i) the predictors are causal (more precisely, V(p)εH^{∞} and \hat{K}(iω)=V(iω)K(iω) can be extended on C⁺ as function \hat{K}(p)εH²∪H^{∞}, where H^{r} denote the set of transfer functions [symbol] holomorphic on C⁺ with finite norm ∥χ∥_{H}_{^{r}}=sup_{s>0}∥χ(s+iω)∥_{L}_{ᵣ}_{(R)},rε[1,+∞].

$$\vert V ( i ω ) \vert = exp ( \frac{2 T γ {ω}^{2}}{{γ}^{2} + {ω}^{2}} ) . \qquad ( ii )$$

(iii) sup_{γ>0}|V(iω)|≦e^{T|ω|}.
(iv) V(iω)→1 as γ→+∞ for all ωεR.
(v) For any ε>0, Ω>0, and γ≧2TΩ²ψ(ε)⁻¹, we have that |V(iω)−1|≦ε for any ωε[−Ω,Ω].

Let us explain why Property 5.6 holds. Set Q(iω)=e^{-iωT}K(iω), i.e., K(iω)=e^{iωT}Q(iω). Clearly,

$$\begin{matrix}Q ( i ω ) = {e}^{- i ω T} {\int }_{- T}^{0} {e}^{- iω t} k ( t ) d t \\ = {\int }_{0}^{T} {e}^{- i ω ( T - θ )} k ( - θ ) d θ \\ = {\int }_{0}^{T} {e}^{- iω τ} k ( τ - T ) d τ .\end{matrix}$$

It follows that Q(iω) can be extended on C⁺ as function Q(p)εH²∪H^{∞}.

Further, V(p)=e^{-Tp}e^{g(p)} and

$$g ( p ) = T \frac{γ - p}{γ + p} p = T \frac{- γ - p + 2 γ}{γ + p} p = - Tp + T \frac{2 γ p}{γ + p} .$$

It follows that e^{g(p)}εH^{∞}. Hence \hat{K}(iω)=V(iω)K(iω)=Q(iω)e^{g(iω)} can be extended on C⁺ as function \hat{K}(p)εH²∪H^{∞}. Then statement (i) follows.

Further,

$$g ( i ω ) = T \frac{γ - i ω}{γ + iω} iω = T \frac{{( γ - i ω )}^{2}}{{γ}^{2} + {ω}^{2}} i ω = T \frac{{γ}^{2} - 2 γ iω - {ω}^{2}}{{γ}^{2} + {ω}^{2}} iω . \\ Then$$

$$Re h ( iω ) = Re g ( iω ) = \frac{2 T {γω}^{2}}{{γ}^{2} + {ω}^{2}} .$$

Then statement (ii) follows.

Let us find maximum of Re h(p) Re h(p,γ) in γ≧0. It suffices to find γ such that

$$\frac{\partial }{\partial γ} Re h ( iω ) = 0 ,$$

i.e., such that

$$\begin{matrix}\frac{\partial }{\partial γ} ( \frac{2 T γ {ω}^{2}}{{γ}^{2} + {ω}^{2}} ) = \frac{2 T {ω}^{2} ( {γ}^{2} + {ω}^{2} ) - 4 T {ω}^{2} {γ}^{2}}{{( {γ}^{2} + {ω}^{2} )}^{2}} \\ = 2 T {ω}^{2} \frac{{γ}^{2} + {ω}^{2} - 2 {γ}^{2}}{{( {γ}^{2} + {ω}^{2} )}^{2}} \\ = 0.\end{matrix} \qquad ( 5.11 )$$

It is easy to see that (5.11) holds for γ=|ω|. For this γ=|ω|, we have that

$$Re h ( iω ) = \frac{2 T γ {ω}^{2}}{{γ}^{2} + {ω}^{2}} = \frac{2 T \vert ω \vert {ω}^{2}}{2 {ω}^{2}} = T \vert ω \vert .$$

Hence (iii) follows.

We have that

$$h ( p ) = h ( p , γ ) = - Tp \frac{2 p}{γ + p} .$$

Hence h(iω,γ)→0 as γ→+∞ for any ωεR. Then statement (iv) follows.

Further, it follows from continuity of the exponent function that there exists a function ψ(•): (0, +∞)→(0, +∞) such that if |h(iω)|≦ψ(ε) then |V(iω)−1|<ε. Let an arbitrarily small ε>0 and an arbitrarily large Ω>0 be given. Take γ=γ(ε)≧2TΩ²ψ(ε)⁻¹, then

$${\vert h ( iω ) \vert}^{2} = \frac{4 {T}^{2} {ω}^{4}}{{γ ( ɛ )}^{2} + {ω}^{2}} \leq {ψ ( ɛ )}^{2}$$

$$∀ ω ∈ [ - Ω , Ω ] , \\ i . e . , \\ \vert V ( iω ) - 1 \vert \leq ɛ$$

$$∀ ω ∈ [ - Ω , Ω ] .$$

Then statement (v) follows. This shows that Property 5.6 holds.

Let [symbol] be a class of processes x(•) from L₂(R)∩L₁(R). Let rε[1,+∞].
(i) We say that the class [symbol] is Lᵣ-predictable in the weak sense with the prediction horizon T if, for any k(•)ε [symbol] ( [symbol] ), there exists a sequence

$${\{ {\hat{k}}_{m} ( \cdot ) \}}_{m = 1}^{+ ∞} = {\{ {\hat{k}}_{m} ( \cdot , \overline{χ} , k ) \}}_{m = 1}^{+ ∞} ⋐ \hat{K} such that$$

$${‖ y - {\hat{y}}_{m} ‖}_{{L}_{r} ( R )} \to 0 as m \to + ∞$$

$$∀ x ∈ χ , \\ where$$

$$y ( t ) {=}^{△} {\int }_{t}^{t + T} k ( t - s ) x ( s ) d s , {\hat{y}}_{m} ( t ) {=}^{△} {\int }_{- ∞}^{t} {\hat{k}}_{m} ( t - s ) x ( s ) d s .$$

The process ŷₘ(t) is the prediction of the process y(t) which describes depends on the future values of process x(s)|_{sε[t,t+T]}.
(ii) Let the set [symbol] ( [symbol] ) [symbol] {X= [symbol] x, xε [symbol] } be provided with a norm ∥•∥. We say that the class [symbol] is Lᵣ-predictable in the weak sense with the prediction horizon T uniformly with respect to the norm ∥•∥, if, for any k(•)ε [symbol] ( [symbol] ), there exists a sequence {\hat{k}ₘ(•)}={\hat{k}ₘ(•, [symbol] k, ∥•∥)}⊂ [symbol] such that ∥y−ŷ∥_{L}_{ᵣ}_{(R)}→0 uniformly in {xε [symbol] :∥X∥≦1}.

Here y(•) and ŷₘ(•) are the same as above.

For qε{1,2}, let [symbol] (q)= [symbol] (q,T) be the set of processes x(•)εL₂(R)∩L₁(R) such that

$${\int }_{- ∞}^{+ ∞} {e}^{qT \vert ω \vert} {\vert X ( iω ) \vert}^{q} d ω < + ∞ , X ( iω ) = Fx$$

For Ω>0 set D(Ω) [symbol] R\(−Ω,Ω).

Clearly, if x(•)ε [symbol] (q,T), then

∫_{D(Ω)}e^{qT|ω|}|X(iω)|^{q}dω→0 as Ω→+∞.

It can be seen also that, for any T>0 the class [symbol] (q,T) includes all band-limited processes x such that X(iω)= [symbol] xεL_{q}(R), qε{1,2}.
Property 5.7 Let qε{1,2}. Set r=∞ for q=1 and r=2 for q=2.
(i) The class [symbol] (q,T) is Lᵣ-predictable in the weak sense with the prediction horizon T.
(ii) Let U(q)=(q,T) be a class of processes x(•)ε [symbol] (q,T) such that ∫_{D(Ω)}e^{qT|ω|}|X(iω)|^{q}dw→0 as Ω→+∞ uniformly on x(•)εU(q). Then this class U(q,T) is Lᵣ-predictable in the weak sense with the prediction horizon T uniformly with respect to the norm ∥•∥_{L}_{_{q}}_{(R)}.

Let us show that Property 5.7 is satisfied. It suffices to present a set of predicting kernels \hat{k} with desired properties. Let V(•) V(γ,•) be as defined in 5.3. Set \hat{K}(iω) [symbol] V(iω)K(iω). Let the predicting kernels be defined as \hat{k}(•)=\hat{k}(•,γ(ε))= [symbol] ¹\hat{K}(iω).

For x(•)εL_{q}(R), let X(iω) [symbol] [symbol] x, Y(iω) [symbol] [symbol] y=K(iω)X(iω). Set Ŷ(iω) [symbol] \hat{K}(iω)X(iω)=V(iω)Y(iω) and ŷ= [symbol] ⁻¹Ŷ.

Let us prove (i). Since K(iω)εL_{∞}(R) and X(iω)εL_{q}(R), we have that Y(iω)=K(iω)X(iω)εL_{q}(R) and Ŷ(iω)εL_{q}(R). By Property 5.6(iv), it follows that

Ŷ(iω)→Y(iω) for a.e. ωεR as γ→+∞. (5.12)

We have that e^{T|ω|}XεL_{q}(R), K(iω)εL_{∞}(R) and

|\hat{K}(iω)−K(iω)|≦|V(iω)−1∥K(iω)|≦2e^{T|ω|}|K(iω)|,ωεR, (5.13)

|Ŷ(iω)−Y(iω)|≦2e^{T|ω|}|K(iω)∥X(iω)|,ωεR. (5.14)

By (5.12),(5.14), and by Lebesgue Dominated Theorem, it follows that

∥Ŷ(iω)−Y(iω)∥_{L}_{_{q}}_{(R)}→0,ωεR, i.e. ∥ŷ−y∥_{L}_{ᵣ}_{(R)}→0, as γ→+∞. (5.15)

Let us prove (ii). Let ε>0 be given, and let Ω(ε) [symbol] ε⁻¹. By Property 5.6(v), there exists γ=γ(ε)>0 such that |V(iω)−1|^{q}≦ε for all ωε[−Ω(ε), Ω(ε)]. For this γ=γ(ε), we have

$${‖ \hat{Y} ( i ω ) - Y ( iω ) ‖}_{{L}_{q} ( R )}^{q} \leq {\int }_{- Ω ( ɛ )}^{Ω ( ɛ )} {\vert V ( iω ) - 1 \vert}^{q} {\vert K ( iω ) \vert}^{q} {\vert X ( iω ) \vert}^{q} d ω + {\int }_{D ( Ω ( ɛ ) )} {\vert V ( iω ) - 1 \vert}^{q} {\vert K ( iω ) \vert}^{q} {\vert X ( iω ) \vert}^{q} d ω \leq {‖ K ( iω ) ‖}_{{L}_{∞} ( R )}^{q} ( {ɛ}^{q} {‖ X ( iω ) ‖}_{{L}_{q} ( R )}^{q} + 2 {\int }_{D ( Ω ( ɛ ) )}^{ } {e}^{qT \vert ω \vert} {\vert X ( iω ) \vert}^{q} d ω ) . \qquad ( 5.16 )$$

Take ε→0. By (5.16), it follows that ∥Ŷ(iω)−Y(iω)∥_{L}_{_{q}}_{(R)}^{q}→0 and ∥ŷ−y∥_{L}_{ᵣ}_{(R)}→0 uniformly over U(q)∩{x(•):∥X(iω)∥_{L}_{_{q}}_{(R)}≦1}.

By (5.15),(5.16), it follows that the predicting kernels \hat{k}(•)=\hat{k}(•,γ(ε))= [symbol] ⁻¹K(iω) are such as required. This shows that Property 5.7 holds.

What is claimed is:

1. We claim ownership of method of predicting of processes consisting of two steps: first, separation of a process on band-limited and high-frequency components, and second, approximation of the transfer function of the anticausal integral to be predicted by a transfer functions for causal convolution integrals.

2. We claim the transfer functions for the predicting blocks that have to be used for the filtered processes, i.e., immediately after the application of filters. These transfer functions are supposed to be used as the limits that can be approximated by linear circuits with rational fractions as transfer functions. More precisely, we claim the transfer function for the predicting system block for band-limited processes and high-frequency processes; these processes can to be obtained as the outcome of a low-pass filter applied to the original process in the framework of claim 1.

3. We claim the transfer function for the predictors that can be used for prediction on the finite horizon of some processes that are not necessarily band-limited but such that the energy on the higher frequency with an exponential rate of decay. These processes can be obtained as the outcome of a low-pass filter applied to the original process in the framework of claim 1, in the case when the filter is not perfect and there is some remaining energy on higher frequencies domains.
New circuits and transfer functions for the low-pass or high-pass filters mentioned above are not suggested and therefore are not claimed.
